(19) United States
(12) Patent Application Publication
(10) Pub. No.: US 2002/0143867 A1
(43) Pub. Date: Oct. 3, 2002

(54) Network server system, method of communicating game data performed in the system, and pogram for executing the method

(75) Inventor: Kentaro Horikawa, Tokyo (JP)

Correspondence Address: SUGHRUE MION, PLLC, 2100 PENNSYLVANIA AVENUE, N.W., WASHINGTON, DC, 20037, US

(73) Assignee: KONAMI CORPORATION

(21) Appl. No.: 10/103,851

(22) Filed: Mar. 25, 2002

(30) Foreign Application Priority Data
Mar. 27, 2001 (JP) 2001-088955
Nov. 21, 2001 (JP) 2001-356171

(51) Int. Cl. G06F 15/16; G06F 19/00; G06F 17/00; A63F 13/00; A63F 9/24

(52) U.S. Cl. 709/203; 463/1

(57) ABSTRACT

A network server system in which a plurality of platforms and a game management station server are connected via a network is provided. A data file is prepared at each platform, based on a single data format. Each prepared data file is uploaded to the game management station server via the network. A game is executed in the game management station server, based on each uploaded data file. Game result data derived from the game are downloaded to the respective platforms via the network.

### BACKGROUND OF THE INVENTION

The present invention relates to a network server system, a method of communicating game data performed in the network server system, and a program for executing the game data communicating method. More specifically, the present invention relates to a method of communicating simulation game data performed in a network server system compatible with a so-called multi-platform network which may consist of different types of platforms.

Various types of simulation games, such as baseball games, soccer games, and war games, have hitherto been provided, and users derive a lot of pleasure from the games. In relation to some of these simulation games, users access a server from their platforms (i.e., terminals) by way of a network, and the users play a game on the server.

However, such a simulation game, which is to be played over the network, is limited to one which is to be played through use of platforms of the same type. The simulation game suffers a problem that the game cannot be played through use of platforms of different types (e.g., a personal computer and a game machine).

### SUMMARY OF THE INVENTION

It is therefore an object of the present invention to provide a network server system, a method of communicating game data performed in the network server system and a program for executing the method, which enable users to derive pleasure from a game through use of platforms of different types.

In order to achieve the above object, according to the present invention, there is provided a network server system, comprising:

a plurality of platforms;

a game management station server;

a network, through which the platforms and the game management station server are connected;

a data file provider, which prepares a data file in each platform based on a single data format;

an uploader, which uploads each prepared data file to the game management station server via the network;

a game executer, which executes a game in the game management station server based on each uploaded data file; and

a downloader, which downloads game result data derived from the game to the respective platforms via the network.

Preferably, the platforms includes at least one different type of platform.

In the above configuration, each of the platforms prepares a data file of a certain format used for all date files, and a game is played on the basis of the data files. Hence, users can enjoy playing a game through use of platforms of different types.

Preferably, the data file includes: shared data, having a first header and a first fixed-length record; reply request data, having a second header and a second fixed-length record; and platform inherent data, having a third header and a third fixed-length record. The first header, the second header and the third header are based on an identical header format. The first fixed-length record, the second fixed-length record and the third fixed-length record are based on an identical fixed-length record format.

In this configuration, the size of a data file remains unchanged. As a result, the data files are made so as to be identical in format and size, whereby handling of the data files can be facilitated.

Here, it is preferable that the shared data includes an user ID based on an e-mail address, which is assigned to a player of the game.

In this configuration, identification can be readily made as to which results are to be downloaded to which of the platforms.

Preferably, that the reply request data includes at least one variable flag. Here it is preferable that a setting of the flag is determined by a player of the game. For example, the player can readily select data desired to be downloaded, by selecting an icon corresponding to the flag showing the kind of desired data. Alternatively, the setting of the flag may be automatically determined in accordance with a type of each platform.

Preferably, the game management station server includes a first folder and a second folder. The uploaded data files are stored in the first folder and the game result data are stored in the second folder.

In this configuration, since the uploaded data files and the game result data are respectively stored in different folders, they are not mixed and can be processed efficiently.

According to the present invention, there is also provided a method of communicating game data, comprising the steps of:

providing a network server system in which a plurality of platforms and a game management station server are connected via a network;

providing a single data format;

preparing a data file at each platform, based on the data format;

uploading each prepared data file to the game management station server via the network;

executing a game in the game management station server, based on each uploaded data file; and

downloading game result data derived from the game to the respective platforms via the network.

Preferably, the method further comprises the step of providing at least one different type of platform among the platforms.

Preferably, the method further comprises the steps of:

determining a content of game result data to be downloaded; and

changing the content of game result data in accordance with the determination, before the downloading step.

Here, it is preferable that the content of game result data is determined by a player of the game. Alternatively, the content of game result data may be automatically determined in accordance with a type of the platform to which the game result data is downloaded.

According to the present invention, there is also provided a program for causing a computer to execute the above game data communicating method.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing one example of the overall configuration of a net work server system according to one embodiment of the present invention;

FIG. 2 is a diagram showing the configuration of a data file;

FIG. 3 is a diagram showing functional blocks of the network server system according to the embodiment shown in FIG. 1;

FIG. 4 is a diagram showing a state in which data files are uploaded from platforms to a server in connection with the embodiment shown in FIG. 1;

FIG. 5 is a flowchart showing processing for communicating data in connection with the embodiment shown in FIG. 1; and

FIG. 6 is a diagram showing a state in which the data files are downloaded to the platforms from the server in connection with the embodiment shown in FIG. 1.

### DETAILED DESCRIPTION OF THE PREFERRED EMBODIMENTS

With reference to the accompanying drawings, one embodiment of the present invention will be described in detail while taking a baseball game system as one example. The baseball game is one type of so-called team management simulation game. An individual player owns his/her baseball team and causes the team to play baseball games in a game space provided on a server for competing with each other.

In more detail, in accordance with predetermined standards each player imparts, to each of baseball players constituting the baseball team within the game space on each platform, capability (e.g., hitting for power, base running skill, fielding skill, bunting skill, and cuttoff skill for a fielder; or the speed of a fastball, the power of various types of breaking balls such as a curve ball, pickoff skills, and stamina). The ability of the baseball team constituting of the baseball players imparted with capabilities on each platform are uploaded to the server in the form of data. The baseball team is caused to have a match, on the server, with an opponent baseball team uploaded from another platform, thus competing for winning or defeat.

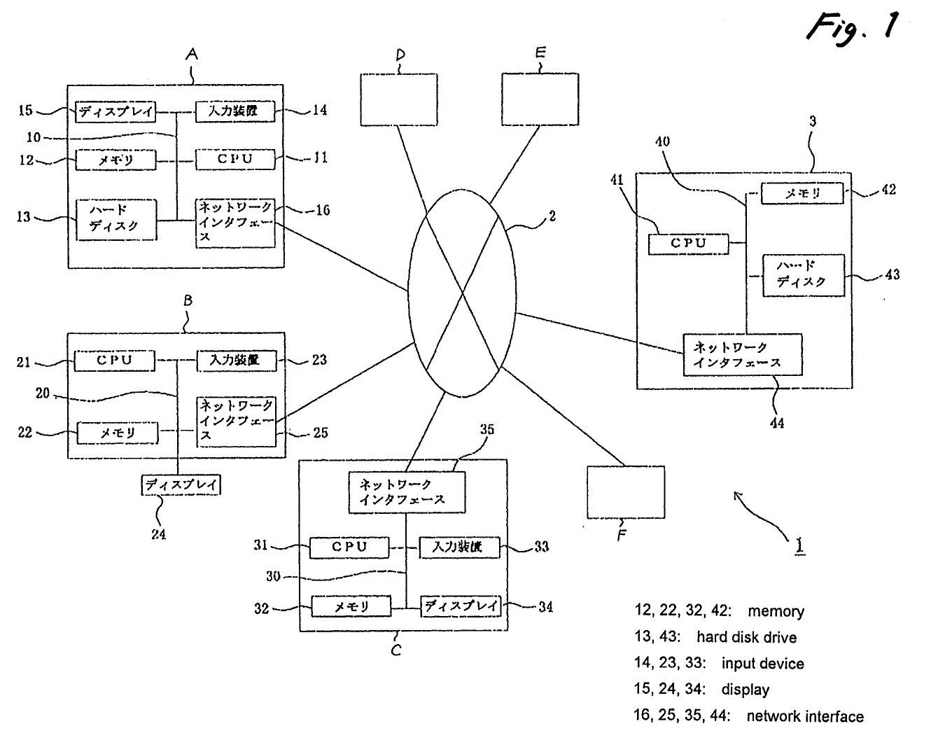

FIG. 1 is a block diagram showing an example of overall configuration of a network server system 1 according to one preferred embodiment of the present invention. A network 2, which is a communication network such as the Internet or an intranet, is connected with a plurality of platforms (i.e., terminals) A, B, C, D, E, and F and with a server 3 acting as a game management station.

The platforms A through F are composed of different types of devices; e.g., a personal computer (a desktop personal computer or a notebook personal computer), a game machine (e.g., PlayStation™, GameCube™), a portable cellular phone, or the like.

As shown in FIG. 1, the platforms A and D denote personal computers. The platform A has a CPU (central processing unit) 11, memory 12, a hard disk drive 13, an input device 14 such as a keyboard, and a display 15 serving as a display device, which are all interconnected together by way of a bus 10. The platform D is substantially identical in construction with the platform A, and hence its detailed illustration and explanation are omitted.

The platforms B and E denotes game machines. The platform B has a CPU 21, memory 22, and an input device 23, which are all interconnected by way of a bus 20. The platform B is connected to a TV 24 serving as a display device. The platform B is connected to the network 2 by way of a network interface 25 provided on the bus 20. The platform E is substantially identical in construction with the platform B, and hence its detailed illustration and explanation are omitted.

The platforms C and F denote portable cellular phones. The platform C comprises a CPU 31, memory 32, an input device 33, and a display 34 serving as a display device, which are all interconnected by way of a bus 30. The platform F is substantially identical in construction with the platform C, and hence its detailed illustration and explanation are omitted.

The constructions of the platforms A through F are mere exemplar illustrations, and platforms having other configurations may be employed.

The server 3 comprises at least a CPU 41, memory 42, and a hard disk drive 43 serving as a storage device, which are all interconnected by way of a bus 40. The server 3 is connected to the network 2 by way of a network interface 44 provided on the bus 40.

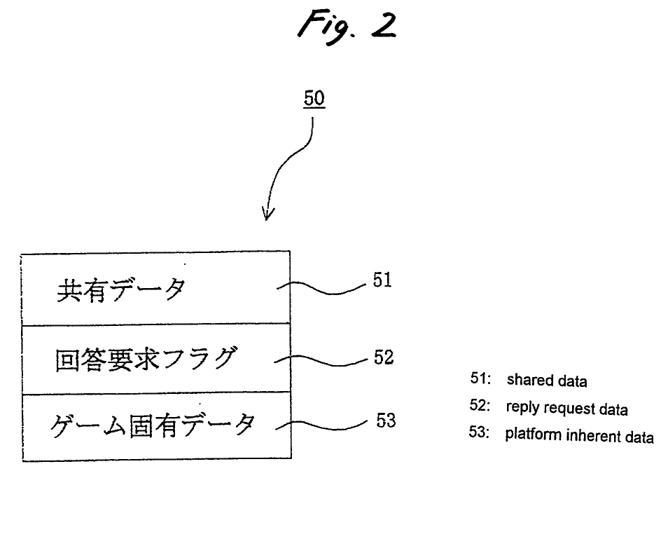

A baseball game application software program loaded from a storage medium (not shown), such as CD-ROM, has been previously installed in the memory 12 of the platform A, in the memory 22 of the platform B, in the memory 32 of the platform C, and in the hard disk 13 of the platform A. The application software program is provided with, as an accessory, a transmission program for uploading a data file 50 shown in FIG. 2 to the server 3. The transmission program may be a well-known program.

FIG. 2 is a diagram showing the configuration of the data file 50 written in the memory 12 of the platform A, that of the data file 50 written in the memory 22 of the platform B, and that of the data file 50 written in the memory 32 of the platform C.

Namely, each of the data files 50 has the same format. More specifically, each of the data files 50 comprises shared data 51, reply request data 52, and the platform inherent data 53. The shared data 51, the reply request data 52, and the platform inherent data 53 have identical headers, and these data sets are each composed of a fixed-length record.

For example, the shared data 51 include a system ID, a game ID, and a user ID. Here, the system ID is a unique ID assigned to a system (e.g., assigned to Konami Corporation). The game ID is an ID assigned to a game to be played by a user (e.g., a baseball game system). The user ID is an ID used for determining a user (player). As will be described later, an E-mail address is preferably used as the user ID, so as to facilitate the identification required when a game result is downloaded to the platforms A through F from the server 3.

The reply request data 52 include flags showing the type of data when a game result is downloaded to the platforms A through F from the server 3, which are set in accordance with the player's wish or the performance of the platform. In the present embodiment, eight flags, b0, b1, b2, b3, b4, b5, b6, and b7, are prepared as the reply request data 52.

Of the flags, flag b0 is relevant to the hitting of a home run. When the player sets flag b0 to “1,” data pertaining to home runs that have been hit in the game are downloaded. In contrast, when the player sets flag b0 to “0,” data pertaining to home runs are not downloaded.

Flag b1 is relevant to whether to download all the plays that have been conducted in a game. When the player sets flag b1 to “1,” data pertaining to all the plays that have arisen during the game are downloaded. In contrast, when the player sets flag b1 to “0,” data pertaining to only highlights of the game are downloaded.

Flag b2 is relevant to whether to request detailed information about the game (e.g., the first ball pitch thrown to the first batter in the top of the third inning was a curve ball, and the batter swung wide). When the player sets flag b2 to “1,” detailed information is downloaded. When the player sets flag b2 to “0,” only the result of the relevant play (e.g., the batter was retired, etc.) is downloaded.

Flag b3 is relevant to whether to request playback information about the game. When the player sets flag b3 to “1,” playback information about the game is downloaded. When flag b3 is set to “0,” only text is downloaded.

Flags b4 through b7 are backup flags and are intended to be relevant to presence or absence of a request for visual information (e.g., information about orientation of a camera angle from center field to the backstop or information about orientation of a camera angle from a position behind the backstop to center field) or audible information (e.g., information as to whether or not sound is made compatible with surround sound).

In the present embodiment, eight flags are available for the reply request data 52. The number of flags may be increased or decreased. Alternatively, details about the reply request data 52 may be changed so as to differ from those mentioned above. Moreover, the reply request data 52 may be automatically set in agreement with the performance of the platforms A through F. In this case, when the data file 50 is stored in each memory of the platforms A through F, identification of the type of platform may be performed so as to provide suitable flag settings with respect to each of the platforms A through F.

The platform inherent data 53 comprise team data pertaining to baseball players constituting the baseball team, and game history data pertaining to the games that have been played by the baseball team in the past.

Stored in the hard disk drive 43 of the server 3 is a processing program for carrying out a game on the basis of the platform inherent data 53 (particularly team data) uploaded from the platforms A through F. The processing program principally carries out a game by determining inferiority or superiority, by comparing the skills of the players, which assume the form of data, with each other one by one. The processing program is a well-known program and does not constitute the gist of the present invention, and hence its detailed explanation is omitted. The processing program is provided with a transmission program, as an accessory, which downloads data into the platforms A through F. The transmission program may be a well-known program.

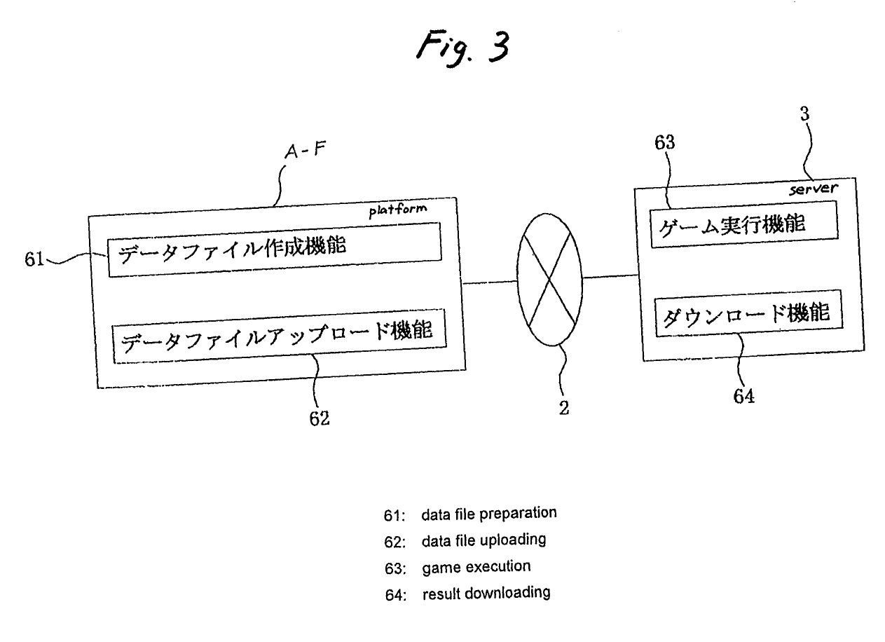

FIG. 3 is a diagram showing the functional block of the network server system 1. The functions to be embodied by the network server system 1 include data file preparation 61, data file uploading 62, game execution 63, and result downloading 64. The server 3 executes the processing program stored in the hard disk drive 43 and the respective platforms A through F execute the processing program stored in the memory 12, 22, 32 or the hard disk drive 13, so that the functions shown in this figure are respectively embodied.

The data file preparation 61 is to prepare a data file 50 of a certain format in each of the platforms A through F. The data file uploading 62 is to upload the data file 50 prepared by the data file preparation 61 to the server 3 by way of the network 2. The game execution 63 carries out a game on the basis of the data file 50 in the server 3. The result downloading 64 is to download to the respective platforms A through F a result from execution of a game.

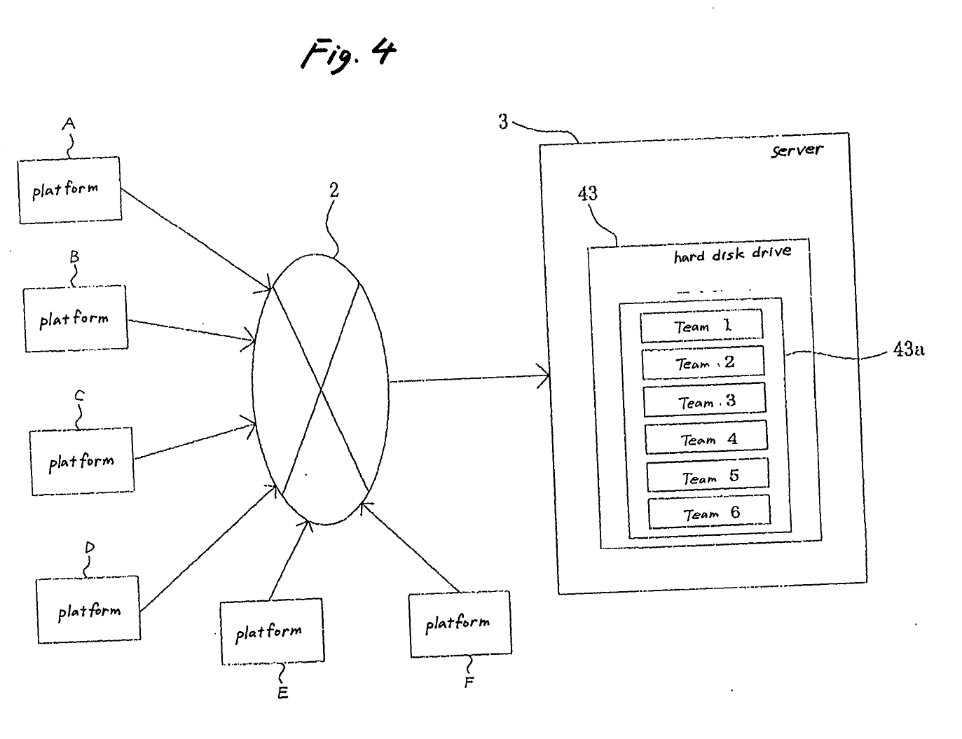

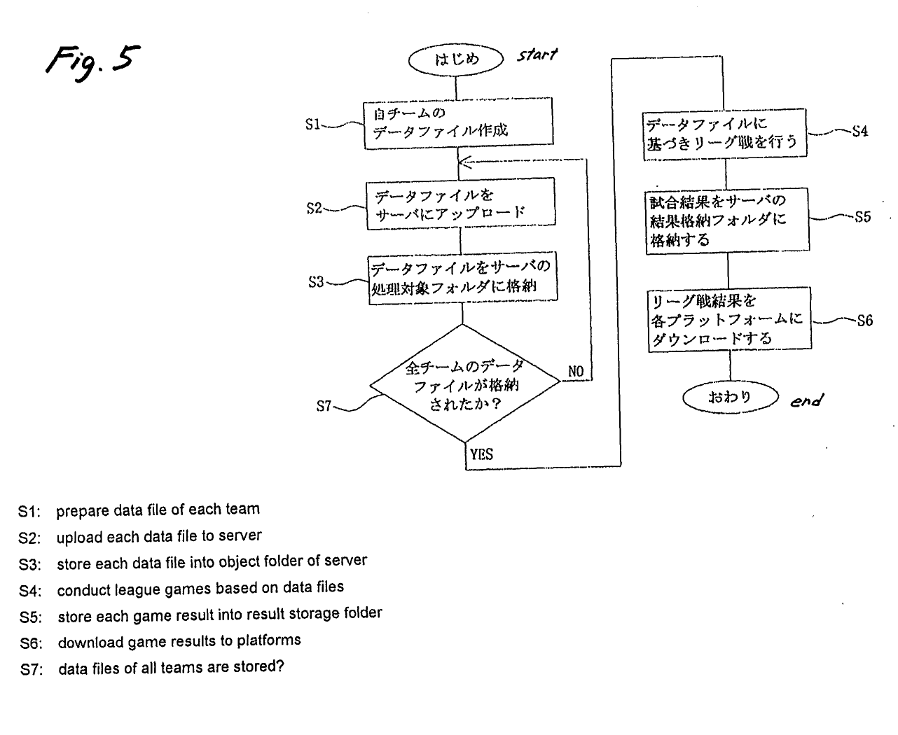

With reference to FIG. 5, there will now be described a manner of playing the game constructed in the manner as mentioned above. First, as shown in FIG. 4, the six platforms A through F and the server 3 are connected to the network 2. The platforms A through F are of different types.

By the data file preparation 61, the first player transforms the ability of a baseball team prepared in the platform A into data (S1). By the data file uploading 62, the thus-prepared data file 50 is uploaded to the server 3 by way of the network 2 (S2). The thus-uploaded data file 50 pertaining to the baseball team of the first player is stored, as “Team 1,” in an object folder 43a in the hard disk 43 which is to be processed by the server 3 (S3).

Similarly, by the data file preparation 61, there are prepared, in the form of data, the ability of the baseball team prepared in the platform B of the second player, the ability of the baseball team prepared in the platform C of the third player, the ability of the baseball team prepared in the platform D of the fourth player, the ability of the baseball team prepared in the platform E of the fifth player, and the ability of the baseball team prepared in the platform F.

By the data file uploading 62, the thus-prepared data files 50 are uploaded to the server 3 by way of the network 2. The thus-uploaded data files 50 pertaining to the baseball teams of the second through sixth players are stored in the object folder 43a of the hard disk drive 43 in the server 3 as “Team 2,” “Team 3,” “Team 4,” “Team 5,” and “Team 6” (S7).

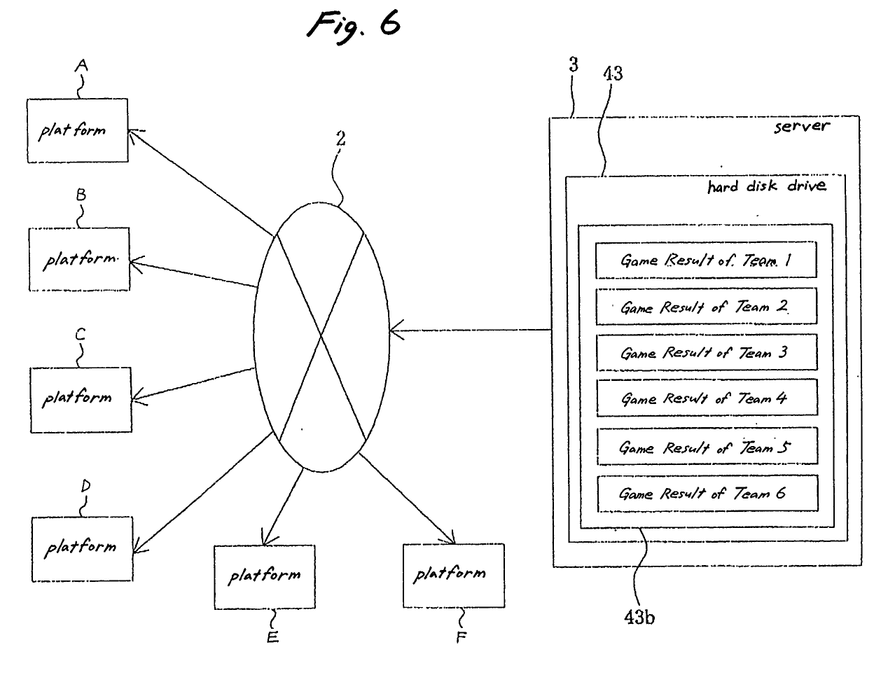

By the game execution 63 of the server 3, there is effected a round of league games consisting of six teams on the basis of the abilities summarized in the respective data files 50, in accordance with the processing program (S4). As shown in FIG. 6, results of the games are stored into a result storage folder 43b of the hard disk drive 43 in the server 3 as “Game Result of Team 1,” “Game Result of Team 2,” “Game Result of Team 3,” “Game Result of Team 4,” “Game Result of Team 5,” and “Game Result of Team 6” (S5).

By the result downloading 64, the thus-prepared league game results are downloaded into the respective platforms A through F (i.e., to the E-mail addresses, which are the user IDs contained in the data files 50), in accordance with the flag setting of the reply request data 52 in the data files 50 uploaded to the server 3 by the transmission program (S6). By viewing the thus-downloaded data, the respective players can ascertain the game results.

According to the configuration as has been described heretofore, since the respective platforms A through F prepare the data files 50 of identical format and a game is played on the basis of the data files 50, users can enjoy playing a game through use of the platforms A through F of different types.

Since the data sets 51 through 53 are each composed of fixed-length data, the sizes of the data files 50 of identical format remain unchanged. For these reasons, the data files 50 can be handled readily.

Since the user IDs contained in the shared data 51 are E-mail addresses, at the time of downloading of the results to the platforms A through F a determination can be readily made as to which results are to be sent to which of the platforms A through F. Thus, the data files 50 can be downloaded efficiently.

Since desired data can be downloaded by changing only the flag settings in the reply request data 52, the data can be downloaded readily.

The server 3 has the hard disk drive 43 comprising the object folder 43a and the result storage folder 43b. The uploaded data files 50 are stored in the object folder 43a, and the result data produced as a result of execution of a game is stored in the result storage folder 43b. Hence, the uploaded data files 50 do not mix with the result data, within the hard disk drive 43. Uploading of the data file 50 and preservation of the game result are effected, by accessing corresponding folders. Thus, the data files 50 and the results can be efficiently processed.

The present invention is not limited to the embodiment set forth and is susceptible to various modifications within the scope of the invention described in the appended claims. Needless to say, such modifications fall within the scope of the invention.

The embodiment has described the present invention by taking a baseball game as an example. However, the present invention can also be applied to another simulation game (e.g., a sport game such as a soccer game or a basketball game or an international war game).

The present embodiment employs platforms of different types. Needless to say, the present invention can be used by use of platforms of the same type.

What is claimed is:

1. A network server system, comprising:
a plurality of platforms;
a game management station server;
a network, through which the platforms and the game management station server are connected;
a data file provider, which prepares a data file in each platform based on a single data format;
an uploader, which uploads each prepared data file to the game management station server via the network;
a game executer, which executes a game in the game management station server based on each uploaded data file; and
a downloader, which downloads game result data derived from the game to the respective platforms via the network.

2. The network server system as set forth in claim 1, wherein:
the data file includes:
shared data, having a first header and a first fixed-length record;
reply request data, having a second header and a second fixed-length record; and
platform inherent data, having a third header and a third fixed-length record;
the first header, the second header and the third header are based on an identical header format; and
the first fixed-length record, the second fixed-length record and the third fixed-length record are based on an identical fixed-length record format.

3. The network server system as set forth in claim 2, wherein the shared data includes an user ID based on an e-mail address, which is assigned to a player of the game.

4. The network server system as set forth in claim 2, wherein the reply request data includes at least one variable flag.

5. The network server system as set forth in claim 4, wherein a setting of the flag is determined by a player of the game.

6. The network server system as set forth in claim 4, wherein a setting of the flag is automatically determined in accordance with a type of each platform.

7. The network server system as set forth in claim 1, wherein:
the game management station server includes a first folder and a second folder; and
the uploaded data files are stored in the first folder and the game result data are stored in the second folder.

8. The network system server as set forth in claim 1, wherein the platforms includes at least one different type of platform.

9. A method of communicating game data, comprising the steps of:
providing a network server system in which a plurality of platforms and a game management station server are connected via a network;
providing a single data format;
preparing a data file at each platform, based on the data format;
uploading each prepared data file to the game management station server via the network;
executing a game in the game management station server, based on each uploaded data file; and
downloading game result data derived from the game to the respective platforms via the network.

10. The game data communicating method as set forth in claim 9, further comprising the steps of:
determining a content of game result data to be downloaded; and
changing the content of game result data in accordance with the determination, before the downloading step.

11. The game data communicating method as set forth in claim 10, wherein the content of game result data is determined by a player of the game.

12. The game data communicating method as set forth in claim 10, wherein the content of game result data is automatically determined in accordance with a type of the platform to which the game result data is downloaded.

13. The game data communicating method as set forth in claim 9, further comprising the step of providing at least one different type of platform among the platforms.

14. A program for causing a computer to execute the game data communicating method as set forth in any one of claims 9-13.
